(19) United States
(12) Patent Application Publication
(10) Pub. No.: US 2006/0140846 A1
(43) Pub. Date: Jun. 29, 2006

(54) Method to modify pore characteristics of porous carbon and porous carbon materials produced by the method

(76) Inventors: Jaan Leis, Tartu (EE); Mati Arulepp, Tartu (EE); Anti Perkson, Tartu Maakond (EE)

Correspondence Address: COOPER & DUNHAM, LLP, 1185 AVENUE OF THE AMERICAS, NEW YORK, NY, 10036, US

(21) Appl. No.: 10/554,137

(22) PCT Filed: Apr. 23, 2003
(86) PCT No.: PCT/EP03/04202

§ 371 Date: Jan. 5, 2006

(51) Int. Cl. C01B 31/02

(52) U.S. Cl. 423/445 R; 423/460; 264/44

(57) ABSTRACT

A method to selectively increase in high-density porous carbon materials the pore size of such pores that are too small to be accessible for certain molecules. The method applies to porous carbon materials with a density of at least 0.6 g/cm³, with a microporosity of at least 0.45 cm³/g as measured by benzene absorption and with pore size distribution where at least 20% of the micropores are of size below 10 A. Specific surface of the precursor carbon material is typically >800 m²/g. The method further employs the use of such liquid oxidants for which the precursor material will function as a molecular sieve, water being a preferred such oxidant.

### FIELD OF INVENTION

The present invention relates to microporous carbon and methods for preparing same. In particular, this invention relates to the preparation of carbonaceous electrode material for electric double layer capacitors having a large capacitance per volume, a low resistivity and moderately high bulk density. The carbonaceous material is preferably produced by thermo-chemical carbonizing and subsequently chemical treating of a carbon precursor of mineral carbide origin.

### BACKGROUND OF THE INVENTION

During extensive development of electric double layer capacitors (EDLC), also called ultra-capacitors or supercapacitors, and its components it has been found that the key to a good supercapacitor is a pair of polarizable electrodes, more precisely a carbonaceous electrode material possessing high sorption behavior of electrolyte ions. A general question is how to increase the electrochemically active surface while maintaining the high bulk density of carbonaceous material.

The widespread, so-called activated, carbon materials for EDLC are made by carbonizing organic substrates: resins, tars etc., and subsequently oxidizing the formed carbonaceous material. The yield and structural properties such as porosity and density of electrochemically active carbon materials significantly depend on the nature and properties of carbonaceous raw material. Furthermore, it is recognized that the electric double layer capacity depends strongly on the adsorption interaction of the ions in the pores, and hence the relationship between the pore size and the effective ion size determines the specific EDL capacitance of the carbonaceous electrodes [Salitra et al. J. Electrochem. Soc. 147 (2000), 2486]. U.S. Pat. Nos. 6,043,183 and 6,060,424 describe the manufacturing of high power density and high energy density carbons, respectively, for use in double layer energy storage devices. In prior art the high power density of carbon is related to maximizing the fraction of mesopores ranging between 2.0 to 50.0 nm, whereas the high energy density is related to maximizing the fraction of micropores with a pore size less than 2.0 nm. Another U.S. Pat. No. 5,965,483 describes a process for increasing the fraction of micropores in the range of 0.8 to 2.0 nm in already activated carbon by blending the activated carbon with potassium hydroxide solution subsequently heated at high temperature.

The recommended classification of pores according to IUPAC is that pores, which diameters range between 2 and 50 nm, should be considered as mesopores, and pores with a diameter of below 2.0 nm as micropores.

When the carbon material is characterized by uniform microporous structure and narrow pore size distribution, the respective polarizable electrode most frequently is able to adsorb different amount of positively and negatively charged ions from electrolyte solution. In most commercial organic electrolytes the cations (ammonium, phosphonium, imidazolium etc.) are of a bigger size than the anions (BF₄, PF₆ etc), therefore the negatively charged electrodes are usually limiting the performance of electrical double-layer capacitors. The application of active carbon with different pore size for negatively and positively charged electrodes in EDLC is considered in U.S. patent application No. 2002/0097549.

It is thus an object of this invention to provide a method for improving the carbon micropore size distribution to increase the specific ion capacity of microporous carbon, and hence to increase the energy density of EDLC comprising one or both electrodes from this carbon.

The post-treatment (called activation, oxidation, pore-modification, etc.) of carbonaceous material to create and/or enhance the porosity in carbonaceous substrate is conventionally executed by heating the carbonaceous material impregnated with liquid chemical activation agents such as alkali metal hydroxides, carbonates, derivatives of sulfuric and phosphoric acids, and combinations thereof. Drawback of these methods is the difficulty to wash out from carbon the reaction by-products. More convenient is to tailor carbon pore sizes by oxidation with gaseous oxidizing agents. Traditional oxidizing medium comprises water vapor, carbon dioxide or the mixture of those with a carrier gas such as nitrogen, argon or helium. The oxidation creates pores and increases surface area of the carbonaceous material. There exists an optimum reaction/activation that provides a maximum electrochemical performance for the carbon in the electrolyte solution. A drawback of such activated carbon materials, however, is a substantial loss of substrate, which usually exceeds 30-50 wt. %. An undesirably big amount of lost carbon material is caused by the restricted diffusion of molecules of the oxidizing agent into the inner parts of the carbon particles. At the oxidizing reaction temperature the gaseous oxidants more likely interact with the carbon atoms at surface layers of carbon particles, without penetrating to the core of the particles.

It is a further object of this invention to provide a more productive method for improving the pore size distribution of microporous carbon by specifically oxidizing the carbon in micropores of less than 1.0 nm in size, while minimizing the loss of mass.

It is yet another object of this invention to provide an improved carbon with a narrow pore size distribution.

### SUMMARY OF THE INVENTION

The above objectives of the invention are achieved by a method of enlarging micropores having a size less than a predetermined size in a microporous carbon material comprising the steps of;

selecting a liquid reagent acting as an oxidant at elevated temperature for which the molecules thereof are absorbed in the micropores to be enlarged; impregnating the carbon material with said liquid reagent; and

thereafter heating the carbon material to a temperature exceeding the oxidizing temperature for said reagent.

In a preferred embodiment the porous carbon material used has a bulk density of at least 0.6 g/cm³, a microporosity of at least 0.45 cm³/g as measured by benzene absorption and with a pore size distribution in which at least 20%, preferably at least 30%, more preferably at least 40% of the micropores are of a size less than 1 nm, and a specific surface larger than 800 m²/g, preferably larger than 1000 m²/g; the reagent being water. The microporous carbon material is preferably a carbon powder material having micropores produced by halogenation of a metal or metalloid carbide. Advantageously, the impregnating of the porous carbon material is made by saturating the material at the boiling temperature of the liquid phase, of the reagent and heating the impregnated carbon material at 800-1200° C., preferably at 900° C., in inert gas atmosphere.

The invention also relates to a microporous carbon material having a bulk density of at least 0.6 g/cm³, a specific surface area of 1000-2200 m²/g and a relative specific surface area by pore size showing a maximum peak within the pore size range 0.75-2.1 nm according to the Density Functional Theory, at least 85% of the total surface area resulting from pores with a size less than two times of the peak pore size and less than 10% of the total surface area resulting from pores with a size less than 0.65 nm.

In a preferred embodiment, less than 1% of the total surface area results from pores with a size less than 0.6 nm.

### DESCRIPTION OF THE DRAWINGS

FIG. 1 is a plot of the characteristic XRD spectrum of inventive carbon powders.

FIG. 2 is a graph showing an effect of different oxidative treatments on the pore size distribution of the high-surface area microporous carbon (example 1) according to the Density Functional Theory.

FIG. 3 is a graph showing the pore size distribution of the high-surface area microporous carbon materials of TiC origin according to the Density Functional Theory.

FIG. 4 is a graph showing a dependence of micro-porosity and specific gravimetric and volumetric EIS capacitance of microporous carbon electrodes of TiC origin in 1M TEMA/acetonitrile electrolyte.

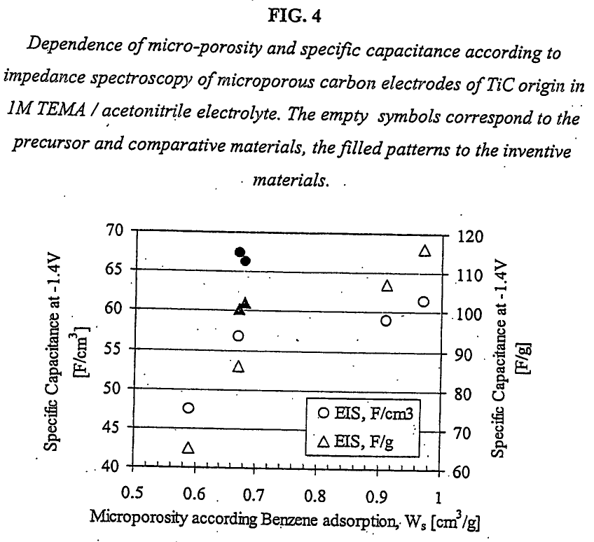

FIG. 5 is a Ragone Plot of “1000F” unpacked supercapacitors showing the advantage of inventive carbon materials (cation-active electrode from the carbon of example 2).

### DESCRIPTION OF THE PREFERRED EMBODIMENTS

The novelty of method is that microporous carbon is used as molecular sieve for the liquid oxidizing agent, which therefore interacts with a carbon in micropores rather than in meso- and macropores. The liquid oxidant gives at elevated temperatures gaseous reaction products that are removed from the carbon by a flow of inert gas.

Oxidizing heat-treatment of the microporous carbon pre-impregnated with oxidizing agent produces carbon material with improved pore characteristics, which makes these carbon materials more suitable for use in EDLCs than previously known activated carbon materials.

These improved characteristics include:

1) an increase of the specific capacitance of the carbon

2) an increase of the deliverable energy density of the carbon

3) a decrease of the electrical resistance of the carbon

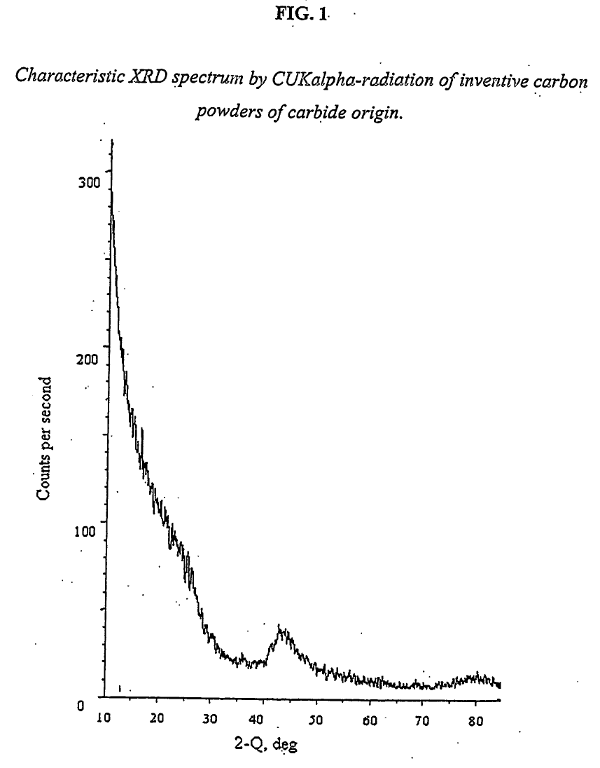

The present invention provides a method for making a highly microporous carbon with dominating pore size of approximately 1 nm. More precisely a carbon with a maximum pore size peak in the small micropore interval end 0.6-0.9 nm for silicon and titanium carbide, a carbon with a peak pore size in the large micropore interval 1.9-2.2 nm with carbides like Mo2C or B4C and a number of tailored carbons within the wider interval 0.75-2.1 by using non-stochiometric metal carbides like TiCl-x where 0.5<x<1.0 for example. A corresponding chemical reaction is expressed by the general equation:
M_{y}C+yz/2X₂→C+yMX_{z}
where subscripts are stoichiometrical constants, X₂ corresponds to a halogen, preferably chlorine, and M denotes the metal or metalloid such as Ti, Si, B or Al. The reaction temperature to yield microporous amorphous carbon depends on the precursor carbide and ranges between 400 and 1100° C. Typical X-ray diffraction spectrum of microporous carbon from above-listed carbides is presented in FIG. 1. The absence of a strong graphite 002 diffraction peak around 2Theta 44 degrees confirms that there is no significant amount of long-range structures in the carbon.

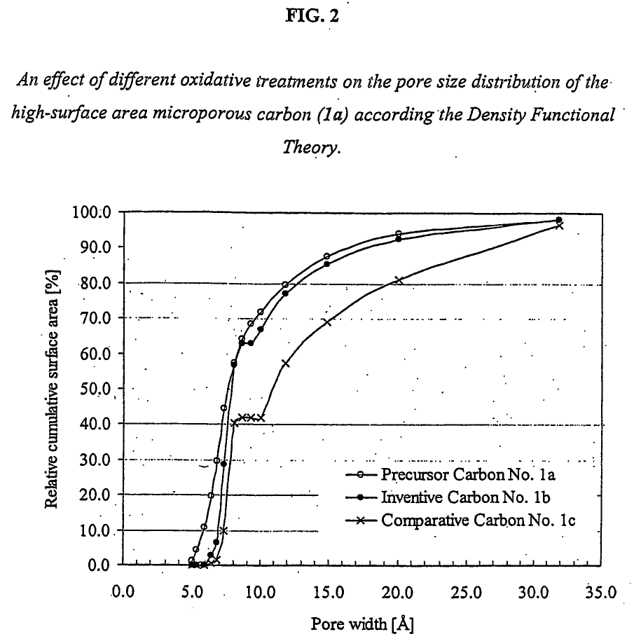

The dominating size of micropores in carbon is particularly determined by the precursor carbide i.e. the position and the distance from each other of carbon atoms in the carbide crystal lattice. Conductivity of carbon particularly depends on the size and shape of the graphene sheets in carbon particles. The ratio of graphitic and disordered amorphous carbon can particularly be controlled by the halogenation conditions: temperature and catalytic ingredients. More precisely, the micrographitic domains in amorphous carbon are created at slightly elevated reaction temperature compared to that needed to form amorphous carbon or by using catalysts, e.g. metals of the iron subgroup in reaction medium. Typical armorphous microporous carbon formed by chlorinating of relevant metal or metalloid carbides have the pore size maximum peak in the interval 0.75-2.1 nm. The pore size distribution tail to larger pore sizes, as meso pores (larger than 2 nm) is surprisingly low. At least 85% of the pores, based on the total surface area, have been observed to have a size less than two times the pore size maximum peak of the specifically reacted metal or metalloid carbide, see for example FIG. 2. The pore distribution tail for pores that are much smaller than the peak size contributes to a considerable extent to the measured specific surface area, but these pores deny access for the commercially used electrolyte ions used in batteries or capacitors. Thus, these small pores do not contribute to the battery or capacitor performance. To optimize the performance of such carbon electrodes the tail representing the smallest sized pores must be reduced. According to the invention an increase of the fraction of electrochemically active micropores in carbon is achieved by filling the micropores with the oxidizing reagent in liquid phase at a temperature below that needed to start the oxidation reaction. When water was used as oxidizing agent the liquid phase treatment of carbon powder was executed in boiling water until the carbon particles precipitated. Other gaseous products giving oxidizing liquids such as e g nitric acid, ammonium nitrate and hydrogen peroxide may be used. Other saturation methods such as vacuum or pressurized filling may be used. After that a wet carbon slurry consisting of approximately 100-200% (wt.) of oxidizing liquid per dry carbon is heated to oxidizing temperature in inert gas atmosphere to obtain a carbon material with moderately widened micropores throughout the whole particle. Different oxidation procedures were systematically studied and the following conclusions are drawn.

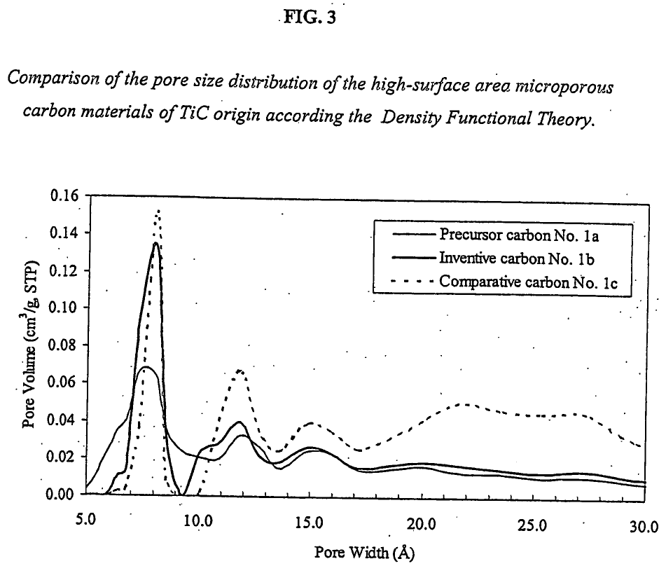

Oxidation of microporous precursor carbon by water considerably reduces the fraction of smallest micropores with a diameter less than 0.7 nm. This effect is observed for the carbon pre-saturated in liquid oxidant with subsequent oxidation in argon flow as well as for the carbon subjected to the prolonged oxidation in the flow of gaseous oxidant (cf. FIGS. 2 and 3). Significant difference in pore-size distribution of those materials is observed at pore sizes above 0.8 nm. When the heating of water saturated carbon material is executed at oxidizing temperature in argon atmosphere, the fraction of micropores of approximately 1.0 nm is more than 10-20% higher than in the carbon oxidized in the flow of water vapor. The flow method needs more time to influence internal micropores. The price to do this is that the surface of particles became overoxidized with unnecessary loss of mass as a result.

Comparison of pore volume data and specific surface areas, presented in Table 1, reveals that in the case of carbon materials derived from TiC (samples 1a-c and 3a-c) the inventive oxidizing treatment, more precisely the heating of the water-impregnated carbon at 900° C., results in marginal increase of respective figures compared to the precursor carbon. The comparative oxidation in flow of water vapors oppositely leads to substantial increase in pore volume. These results are well supported by the relative amounts of oxidized carbon material lost as indicated in Table 1. The advantage of the inventive oxidation method is well seen in specific physical and electrochemical data presented in Table 2. From several test series applying different precursor carbon it is obvious that the inventive oxidizing treatment using pre-impregnation of a liquid reagent influences the porosity and consequently the bulk density of the respective electrodes noticeably less than the comparative treatment in a flow of a gaseous oxidant. Furthermore, while the impregnation method does not change the porosity of precursor carbon, it is obvious that the improved specific capacitance at negative potential values (EIS capacitance at −1.4V is presented in Table 2) is achieved mainly by improving the pore sizes to give better adsorption of cations from the electrolyte solution.

In a carbon having pores being modified in accordance with the method described above less than 10% of the total specific surface area by pore size according to the Density Functional Theory results from pores with a size less than 0.65 nm and less than 1% results from pores with a size less than 0.6 nm.

The surprising effect of liquid-phase impregnation prior to oxidation can be explained by the microporous carbon, comprising pores of less than 0.7-0.8 nm, behaving as “molecular sieve” for the water molecules. Classical water-sieves used to eliminate moisture from organic solvents and to dry gases usually comprise pores of 0.3-1.0 nm. Although molecular sieves consisting of pores of 0.3 to 0.5 nm absorb water molecules more specifically, the sieves comprising pores of 0.5 to 1.0 nm are sometimes preferred in practical applications because these sieves are more easily regenerated, i.e. dried at elevated temperatures. Water that is adsorbed during impregnation in larger micropores is more likely to evaporate during heat-up of the wet carbon slurry, and hence predominantly such molecules that are absorbed in small micropores participate in the oxidation reaction. The molecular sieve effect of small micropores was particularly confirmed by comparative tests: 1) impregnation of carbon in boiling water for 1 h prior to heat-treatment at 900° C. in Argon flow; 2) repeated impregnation and heat treatment using the same routine; and 3) prolonged impregnation (5-6 h) of carbon prior to heat-treatment. When the effect on the pore size distribution and electrochemical properties of carbon were observed after carbon treatment using the first mentioned step 1, there was no further changes after treatment according steps 2 and 3. However, there is opportunity to use the carbon, which is oxidized by absorbed water molecules as described above, to gain a further sieving effect for another, liquid reagent that has somewhat bigger size polar molecules, which can be absorbed by the enlarged micropores in such a carbon. It is thus possible to gain a further tailoring of micropore size by impregnating the carbon having micropores enlarged by the method described above with the use of water, with a second liquid reagent that has a boiling point below decomposition temperature and decomposes to volatile products comprising at least one component that oxidizes carbon.

TABLE 1
Specific surface (S_{BET}) according to BET, pore volume
according to benzene (W_{S}) and nitrogen (Vₜₒₜ) sorption
of different carbon materials (1-5). In sample
numbers, “a” defines the precursor carbon,
“b” - treatment by the inventive method and
“c” - the comparative gas-flow oxidation The
last column refers to the percentage of carbon lost
during oxidative treatment.

| Carbon. | W_{S} | S_{BET} | Vₜₒₜ | Lost Carbon |
|---|---|---|---|---|
| No. | [cm³ g⁻¹] | [m² g⁻¹] | [cm³ g⁻¹] | [%] |
| 1a | 0.67 | 1402 | 0.72 | — |
| 1b | 0.68 | 1555 | 0.78 | 4 |
| 1c | 0.97 | 1987 | 1.09 | 30 |
| 2a | 0.45 | 1083 | 0.54 | — |
| 2b | 0.56 | 1320 | 0.76 | 17 |
| 2c | 0.91 | 1791 | 0.96 | 47 |
| 3a | 0.59 | 1390 | 0.71 | — |
| 3b | 0.67 | 1503 | 0.71 | 15 |
| 3c | 0.91 | 1929 | 0.96 | 39 |
| 4a | 0.47 | 1070 | 0.49 | — |
| 4b | 0.56 | 1200 | 0.63 | 54 |
| 4c | 0.64 | 1397 | 0.75 | 65 |
| 5a | 0.42 | 938 | 0.46 | — |
| 5b | 0.53 | 1188 | 0.59 | 27 |
| 6a | 0.44 | 1031 | 0.50 | — |
| 6b | 0.49 | 1115 | 0.64 | 12 |

TABLE 2
Bulk density, thickness and specific capacitance of electrodes from
different precursors, inventive and comparative carbon materials measured
in 1 M TEMA/AN electrolyte. In sample numbers, “a” defines the
precursor carbon, “b” - the treatment by the inventive method
and “c” - the comparative gas-flow oxidation.

| Carbon | d | EIS [F/g] | | EIS [F/cm³] | | Porosity* |
|---|---|---|---|---|---|---|
| No. | [g/cm³] | −1.4 V | +1.4 V | −1.4 V | +1.4 V | [%] |
| 1a | 0.66 | 86 | 129 | 57 | 85 | 44 |
| 1b | 0.65 | 102 | 132 | 66 | 87 | 44 |
| 1c | 0.53 | 116 | 128 | 61 | 68 | 51 |
| 2a | 0.77 | 59 | 117 | 45 | 90 | 35 |
| 2b | 0.63 | 92 | 134 | 58 | 84 | 35 |
| 2c | 0.53 | 105 | 130 | 55 | 69 | 48 |
| 3a | 0.73 | 65 | 116 | 47 | 84 | 43 |
| 3b | 0.67 | 101 | 138 | 67 | 94 | 45 |
| 3c | 0.56 | 107 | 123 | 59 | 69 | 51 |
| 4a | 0.74 | 53 | 123 | 39 | 91 | 35 |
| 4b | 0.62 | 90 | 128 | 56 | 80 | 35 |
| 4c | 0.63 | 102 | 136 | 64 | 85 | 40 |
| 5a | 0.85 | 50 | 101 | 42 | 86 | 36 |
| 5b | 0.75 | 79 | 107 | 59 | 81 | 40 |
| 6a | 0.83 | 43 | 89 | 36 | 74 | 37 |
| 6b | 0.68 | 63 | 101 | 43 | 69 | 33 |

*Porosity (cm³/cm³) = Wₛ · d · 100%, where Wₛ is pore volume according to Benzene sorption and d is bulk density of the electrode.

One advantage of the method provided by this invention is that presaturation of microporous carbon material with the oxidizing agent prior to starting the oxidizing reaction yields carbon with very narrow pore size distribution tailored to possess superior sorption behavior of the electrolyte ions. Another advantage of the method is that no external flow of oxidizing gas or vapor is applied. Therefore is avoided the undesirable bulk oxidation of surface layers of carbon particles and the yield of electrode carbon material is much higher compared to that obtained by the conventional carbon activation processes of oxidizing in gas/vapor atmosphere at high temperature. An important advantage is also that the bulk density of conductive and highly microporous carbon material is only slightly reduced during the oxidation process. The high density of electrodes is in fact a key to the high volumetric electrochemical characteristics of supercapacitors.

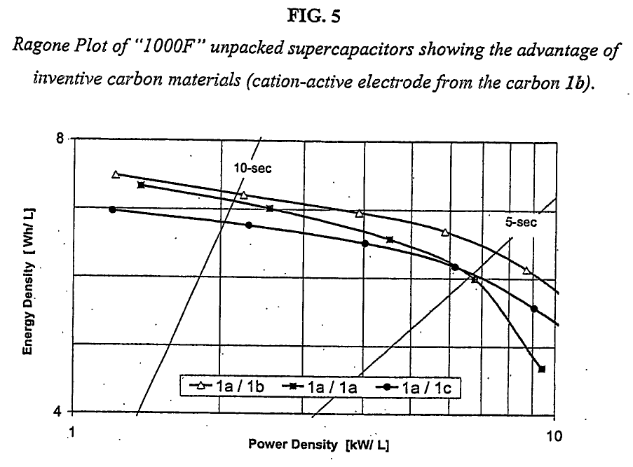

Supercapacitors of approximately 1000F were assembled so that the positively charged electrodes of all devices were composed from the precursor carbon 1a made from TiC. Negatively charged electrodes of SC 348, SC 432 and SC 420 were composed from precursor carbon (1a), inventive carbon (1b) and comparative carbon (1c), respectively. It is seen from Table 3 and from the Ragone plot (FIG. 5) that a capacitor including negatively charged electrodes from inventive carbon has considerable advantage in practical applications. For instance, the “10-second” and “5-second” application parameters shown in FIG. 5 are of practical use in automotive applications.

TABLE 3
Examples of electrochemical performance* of prototype electric
double layer capacitors according to the present invention.

| | Electrode | | Specific | Specific | Energy |
|---|---|---|---|---|---|
| | pair | Volume | Capacitance | Resistance | Stored |
| SC # | +/− | [cm³] | [F cm⁻³] | [Ω cm³] | [Wh L⁻¹] |
| 348 | 1a/1a | 84.2 | 11.67 | 0.040 | 10.1 |
| 432 | 1a/1b | 97.2 | 11.93 | 0.030 | 10.4 |
| 420 | 1a/1c | 97.2 | 10.70 | 0.026 | 9.3 |

*Data for unpacked cells

### EXAMPLE 1

### Typical procedure for preparation of microporous precursor carbon material from fine powder of Titanium Carbide

Titanium carbide (H. C. Starck, grade C.A., 300 g) with an average particle size of 1.3-3 microns was loaded into a quartz rotary kiln reactor and let to react with a flow of chlorine gas (99.999% assay) for 4 h at 950° C. Flow rate of chlorine gas was 1.6/min and rotation speed of reactor tube ˜2.5 rpm. The by-product, TiCl₄, was led away by the stream of the excess chlorine and passed through a water-cooled condenser into a collector. After that the reactor was flushed with Argon (0.5 l/min) at 1000° C. for 1 h to remove the excess of chlorine and residues of gaseous by-products from carbon. During heating and cooling, the reactor was flushed with a slow stream (0.5 l/min) of argon. Resulting carbon powder (47.6 g) was moved into quartz stationary bed reactor and treated with hydrogen gas at 800° C. for 2.5 h to dechlorinate deeply the carbon material. During heating and cooling, the reactor was flushed with a slow stream of Argon (0.3 l/min). Final yield of the carbon material 1a was 45.6 g (75.9% of theoretical).

### EXAMPLE 2

### Inventive carbon material by modification of micropores of the carbon of Example 1

A carbon powder of Example 1 (39 g) was boiled for 2 h in 250 ml water in a round-bottom flask equipped with reflux cooler. After that the carbon was filtered and the paste, containing approximately 2 g water per 1 g carbon was placed in a quartz reaction vessel and loaded into a horizontal quartz reactor heated by a tube furnace. The argon flow was then passed with a flow rate of 0.6 l/min through the reactor and the furnace was heated up to 900° C. using a heat-up gradient of 15°/min. The heating of a carbon at 900° C. was continued in argon flow for 2 h. After that the reactor was slowly cooled to room temperature. The yield of thus modified carbon 1b was 37.5 g (96%).

### EXAMPLE 3

### Comparative carbon material by gas-phase oxidation of the carbon of Example 1

A carbon powder of Example 1 (40 g) was placed in a quartz reaction vessel and loaded into horizontal quartz reactor heated by a tube furnace. Thereupon the reactor was flushed with argon to remove air and the furnace was heated up to 900° C. using a heat-up gradient of 15°/min. The argon flow was then passed with a flow rate of 0.8 l/min through distilled water heated up to 75-80° C. and the resultant argon/water vapor mixture with approximate ratio of 10/9 by volume was let to interact with a carbon at 900° C. for 2.5 h. After that the reactor was flushed with argon for one more hour at 900° C. to complete the activation of a carbon surface and then slowly cooled to room temperature. The yield of thus modified carbon 1c was 28 g (70%).

### EXAMPLE 4

### Typical synthesis of microporous precursor carbon material from Silicon Carbide

Silicon carbide (H. C. Starck, lot. 3481, 60.2 g) with an average particle size of 1 micron was loaded into a quartz rotary kiln reactor and let to react with a flow of chlorine gas (99.999% assay) for 3.5 h at 1100° C. Flow rate of chlorine gas was 1 l/min and rotation speed of reactor tube ˜2.5 rpm. The by-product, SiCl₄, was led away by the stream of the excess chlorine and passed through a water-cooled condenser into a collector. After that the reactor was flushed with Argon (0.5 l/min) at 1100° C. for 1 h to remove the excess of chlorine and residues of gaseous by-products from carbon. During heating and cooling, the reactor was flushed with a slow stream (0.5 l/min) of Argon. The yield of the carbon material 2a was 18 g (99.4% of theoretical).

### EXAMPLE 5

A carbon powder of Example 4 (6 g) was treated as described in Example 2. The yield of thus modified carbon 2b was 5 g (83%).

### EXAMPLE 6

A carbon powder of Example 4 (15 g) was treated as described in Example 3. The yield of thus modified carbon 2c was 7.9 g (52.7%).

### EXAMPLE 7

### Typical preparation of microporous precursor carbon material from Titanium Carbide in fluidized bed

Titanium carbide (Pacific Particulate Materials, lot 10310564, 1000 g) with an average particle size of 70 microns was loaded into a fluidized bed reactor and let to react with a flow of chlorine gas (99.999% assay) for 4 h at 950° C. Flow rate of chlorine gas was 10 l/min. The by-product, TiCl₄, was led away by the stream of excess chlorine and passed through a water-cooled condenser into a collector. After that the reactor was flushed with Argon (5 l/min) at 1000° C. for 0.5 h to remove the excess of chlorine and residues of gaseous by-products from carbon. During heating and cooling, the reactor was flushed with a stream (5 l/min) of argon. Resulting carbon powder (190 g) was moved into quartz stationary bed reactor and treated with hydrogen gas at 800° C. for 2.5 h to dechlorinate deeply the carbon material. During heating and cooling, the reactor was flushed with a slow stream of Argon (0.3 l/min). Final yield of the carbon material 3a was 180 g (90% of theoretical). The carbon powder was milled prior electrode manufacturing.

### EXAMPLE 8

A carbon powder of Example 7 (30.3 g) was treated as described in Example 2. The yield of thus modified carbon 3b was 25.7 g (85%).

### EXAMPLE 9

A carbon powder of Example 7 (5.2 g) was milled and treated as described in Example 3, with exception that the oxidation was prolonged by 1 h. The yield of thus modified carbon 3c was 3.2 g (61%).

### EXAMPLE 10

### Preparation of microporous precursor carbon material from Titanium Carbide using catalyst assisted chlorination

Titanium carbide (H. C. Starck, grade C.A., 250 g) with an average particle size of 1.3-3 microns was thoroughly mixed with cobalt(II) and nickel(II) chlorides solution in ethanol at room temperature, with the final content of 16 mg of each chloride per gram of carbide. Upon that the ethanol was evaporated. The dry reaction mixture was loaded into a quartz rotary kiln reactor and let to react with a flow of chlorine gas (99.999% assay) for 4.5 h at 500° C. Flow rate of chlorine gas was 1.6 l/min and rotation speed of reactor tube ˜2.5 rpm. The by-products were led away by the stream of excess chlorine and passed through a water-cooled condenser into a collector. After that the reactor was flushed with Argon (0.5 l/min) at 1050° C. for 1 h to remove the excess of chlorine and residues of gaseous by-products from carbon. During heating and cooling, the reactor was flushed with a slow stream (0.5 l/min) of argon. Resulting carbon powder (49 g) was moved into quartz stationary bed reactor and treated with hydrogen gas at 800° C. for 3 h to dechlorinate deeply the carbon material. During heating and cooling, the reactor was flushed with a slow stream of Argon (0.3 l/min). Final yield of the carbon material 4a was 46 g (91% of theoretical).

### EXAMPLE 11

A carbon powder of Example 10 (10.1 g) was treated as described in Example 2. The yield of thus modified carbon 4b was 4.7 g (46%).

### EXAMPLE 12

A carbon powder of Example 10 (10 g) was treated as described in Example 3, with exception that the oxidation was prolonged by 1 h. The yield of thus modified carbon 4c was 3.5 g (35%).

### EXAMPLE 13

Activated carbon cloth (Chemviron FM-1/250) was milled to fine powder (sample No. 5a) prior to further treatments and electrode manufacturing.

### EXAMPLE 14

A carbon powder of Example 13 (3.3 g) was treated as described in Example 2. The yield of thus modified carbon 5b was 2.4 g (73%).

### EXAMPLE 15

Activated carbon pellets (Chemviron WS45) were milled to fine powder (sample No. 6a) prior to further treatments and electrode manufacturing.

### EXAMPLE 16

The carbon powder of Example 15 (5.8 g) was treated as described in Example 2. The yield of thus modified carbon 6b was 5.1 g (88%).

Characterization of Carbon Materials According to this Invention

Low temperature nitrogen sorption experiments were performed using Gemini Sorptometer 2375 (Micromeritics). The specific surface area of carbon materials was calculated according BET theory up to the nitrogen relative pressure (P/P₀) of 0.2. The total volume of pores was calculated from nitrogen adsorption at relative pressure (P/P₀) of 0.95, and the pore size distributions from adsorption characteristics according to the Density Functional theory.

Adsorption dynamics of benzene vapours was studied at room temperature using computer controlled weighing of the carbon samples in benzene vapours at normal pressure and room temperature in time. The volume of pores that adsorbed benzene under the above-described conditions, was calculated according to the equation
Wₛ=(m₂−m₁)/m₁·d_{C}_{₆}_{H}_{₆} [cm³g⁻¹]
where m₁ and m₂ are the initial and final weights of the test-sample, respectively, and d_{C}_{₆}_{H}_{₆} is the density of benzene at room temperature.
Method for Preparation of Electrodes

Carbon powder (10 g) was stirred in ethanol and kept at ˜0° C. for 5 minutes. After that 6% wt. of PTFE (as a 60% suspension in water) was added to the slurry, thoroughly mixed and gently pressed until a wet cake was formed. Thereupon the ethanol was evaporated. The cake was then impregnated with heptane, shaped to a cylinder and extruded by rolling the body in the axial direction of the cylinder. This procedure was repeated until elastic properties appeared. Finally the heptane was removed at ˜75°, the extruded cake rolled stepwise down to the desired thickness, preferably 100-115 microns, dried in vacuum at 170° C. and plated from one side with an aluminum layer of 4±1 microns using Plasma Activated Physical Vapor Deposition.

Electrochemical Evaluation of Carbon Materials

The electrochemical tests were performed in a 3-electrode electrochemical cell, using the Solartron potentiostat 1287 with FRA analyzer. Electrochemical experiments were done in an electrolyte comprising 1.0M Triethylmethylammonium tetrafluoroborate (TEMA) in Acetonitrile (AN). During experiments the electrolyte was degassed with Argon. Experiments using constant voltage (CV), constant current (CC), and impedance (EIS) technique were carried out. The region of the ideal polarizabilty was observed between −1.5 to +1.5V (vs. SCE). Discharge capacitance for the negatively and positively charged electrode materials was calculated from the CV and CC plots. The EIS measurements were carried out at AC 5 mV and DC potentials: −1.4V and +1.4V. The EIS capacitance was calculated at frequency of 10 mHz.

Assembling and Preconditioning of Capacitors

The electrodes were attached to Al foil of 10 microns thickness (current collector) and interleaved with a separator. An ion-permeable separator paper from Codashi Nippon was used in the present examples. The electrode pairs from positively and negatively charged polarizable electrodes were connected in parallel. The electrode pack thus prepared was placed in a sealed box, kept at 100° C. under vacuum for three days to remove all gases absorbed and then impregnated with electrolyte comprising a solution of a mixture of 0.75M triethylmethylammonium tetrafluoroborate and 0.75M tetraethylammonium tetrafluoroborate in acetonitrile. The electric double layer capacitor (EDLC) cells thus fabricated were cycled within the voltage range of 1.2-2.5 V under constant current conditions.

Evaluation of Supercapacitors

The constant current (CC) and constant voltage (CV) tests were carried out using the potentiostat Solartron 1287. The nominal voltage of capacitors was estimated from the CV plots. The capacitance of the supercapacitors using discharge from 2.5V to 0V was calculated from CC plots according to the formula: C=Idt/dE. Electrochemical impedance spectroscopy (EIS) was used to determine the series resistance of the capacitor at frequency 10 Hz (DC=2.5V; AC=5 mV).

The power, energy performance and respective Ragone plots were calculated using constant resistance test mode and charge/discharge cycling between 2.5V and 1.25V.

1. A method of enlarging micropores having a size less than a predetermined size in a microporous carbon material comprising the steps of; selecting a liquid reagent acting as an oxidant at elevated temperature for which the molecules thereof are absorbed in the micropores to be enlarged; impregnating the carbon material with said liquid reagent; and thereafter heating the carbon material to a temperature exceeding the oxidizing temperature for said reagent.

2. The method according to claim 1, wherein the porous carbon material has a bulk density of at least 0.6 g/cm³, a microporosity of at least 0.45 cm³/g as measured by benzene absorption and with a pore size distribution in which at least 20%, preferably at least 30%, more preferably at least 40% of the micropores are of a size less than 1 nm, and a specific surface larger than 800 m²/g, preferably larger than 1000 m²/g; the reagent being water.

3. The method according to claim 2, wherein the microporous carbon material is a carbon powder material having micropores produced by halogenation of a metal or metalloid carbide.

4. The method according to claim 1, wherein the impregnating of the porous carbon material is made by saturating the material at the boiling temperature of the liquid phase of the reagent and heating the impregnated carbon material at 800-1200° C., preferably at 900° C., in inert gas atmosphere.

5. A microporous carbon material having a bulk density of at least 0.6 g/cm³, a specific surface area of 1000-2200 m²/g and a relative specific surface area by pore size showing a maximum peak within the pore size range 0.75-2.1 nm according to the Density Functional Theory, at least 85% of the total surface area resulting from pores with a size less than two times of the average? peak pore size and less than 10% of the total surface area resulting from pores with a size less than 0.65 nm.

6. The microporous carbon material according to claim 5, wherein less than 1% of the total surface area results from pores with a size less than 0.6 nm.

7. The method according to claim 2, wherein the impregnating of the porous carbon material is made by saturating the material at the boiling temperature of the liquid phase of the reagent and heating the impregnated carbon material at 800-1200° C., preferably at 900° C., in inert gas atmosphere.

8. The method according to claim 3, wherein the impregnating of the porous carbon material is made by saturating the material at the boiling temperature of the liquid phase of the reagent and heating the impregnated carbon material at 800-1200° C., preferably at 900° C., in inert gas atmosphere.
